(19) United States
(12) Patent Application Publication
(10) Pub. No.: US 2016/0141793 A1
(43) Pub. Date: May 19, 2016

(54) LIQUID PROOF CONNECTOR

(71) Applicant: YAZAKI CORPORATION, Tokyo (JP)

(72) Inventors: Akihiro OSADA, Shizuoka (JP); Kenji TAKAHASHI, Shizuoka (JP); Kazuhide TAKAHASHI, Shizuoka (JP)

(73) Assignee: YAZAKI CORPORATION, Tokyo (JP)

(21) Appl. No.: 14/987,086

(22) Filed: Jan. 4, 2016

Related U.S. Application Data
(63) Continuation of application No. PCT/JP2014/068414, filed on Jul. 10, 2014.

(30) Foreign Application Priority Data
Jul. 19, 2013 (JP) 2013-150713

(51) Int. Cl. H01R 13/52

(52) U.S. Cl. CPC H01R 13/5202

(57) ABSTRACT

A liquid proof connector includes: a connector housing including a recessed-section bottom wall, two joining recessed-sections having joining openings which face each other in reverse directions and which have the recessed-section bottom wall in common, and a terminal holding hole formed in the recessed-section bottom wall; a resin filler that is filled into the connector housing; and a terminal that has two ends each having a rectangular shape cross-section and serving as a portion for connection with a partner terminal, and a circular cross-section part having a portion which is embedded in the resin filler and is formed in a circular shape cross-section, the terminal being inserted into the terminal holding hole so that the two ends project into the joining recessed sections which results in the terminal being held inside the connector housing.

### CROSS REFERENCE TO RELATED APPLICATIONS

This application is a continuation of International Application No. PCT/JP2014/068414, filed Jul. 10, 2014, and based upon and claims the benefit of priority from Japanese Patent Application No. 2013-150713, filed Jul. 19, 2013, the entire contents of all of which are incorporated herein by reference.

### TECHNICAL FIELD

The present application relates to a liquid proof connector to be attached to a case accommodating liquid.

### BACKGROUND ART

Conventionally, as the connector to be attached to a case for accommodating a liquid such as oil as the automatic transmission case of an automobile, and is used liquid proof connector having a liquid proof function.

In JP 2000-040551 A (PTL 1), there is described, as a conventional liquid proof connector, a liquid proof connector which includes: a connector housing including a recessed-section bottom wall, two joining recessed sections having the recessed-section bottom wall in common and joining openings facing each other in opposite directions, and a terminal holding hole formed in the recessed-section bottom. wall; a resin filler filled into the connector housing; and a terminal having both ends each of which has a rectangular shape cross-section and serves as a portion for connection with a partner terminal, the terminal being inserted into the terminal holding hole so that the both ends project into the joining recessed sections respectively, whereby the terminal is held inside the connector housing.

### SUMMARY

In the conventional liquid proof connector 100 described in PTL 1, as illustrated in FIGS. 7A and 7B, the resin filler 30 easily generates cracking and peeling C at the periphery of corners of the terminal 200 due to the difference of thermal expansion between the terminal 200 and the resin filler 30, and the liquid proofing performance of the connector might be degraded with a leakage of liquid through the cracking and peeling C.

In the above-mentioned situation, an object of the present application is to provide a liquid proof connector capable of improving its liquid proofing performance.

A liquid proof connector according to an aspect of the present application includes: a connector housing including a recessed-section bottom wall, two joining recessed sections having the recessed-section bottom wall in common and joining openings facing each other in opposite directions, and a terminal holding hole formed in the recessed-section bottom wall; a resin filler filled into the connector housing; and a terminal including both ends each having a rectangular shape cross-section and serving as a portion for connection with a partner terminal, and a circular cross-section part obtained as a result of forming a terminal's portion embedded in the resin filler so as to have a circular shape cross-section, the terminal being inserted into the terminal holding hole so that the both ends project into the joining recessed sections respectively, whereby the terminal is held inside the connector housing.

As the terminal's portion embedded in the resin filler is formed with circular shape cross-section, a small stress is applied to the resin filler along the circumference of the terminal uniformly. For this reason, the cracking and peeling become hardly generated, thereby resulting in an improvement of the liquid proofing performance.

The circular cross-section part may be formed over a substantially whole area of the terminal except for the both ends.

With such a constitution, the terminal's portion embedded in the resin filler and a peripheral portion of the terminal's portion can be reliably formed with circular shape cross-sections and therefore, it is possible to prevent an occurrence of cracking and peeling at the periphery of the terminal certainly.

### BRIEF DESCRIPTION OF DRAWINGS

FIG. 1 is a perspective view of a liquid proof connector according to an embodiment.

FIG. 2 is a cross-sectional perspective view along a line A-A of the liquid proof connector illustrated in FIG. 1 (including a terminal not illustrated in cross-section).

FIG. 3 is an enlarged perspective view of the terminal of the liquid proof connector according to the embodiment.

FIG. 4A is a view illustrating the result of analyzing stress generated in a case of applying a thermal shock to a liquid proof connector (conventional example) in which a terminal having a rectangular cross-section is embedded in a resin filler, and FIG. 4B is a view illustrating the result of analyzing stress generated in a case of applying a thermal shock to the liquid proof connector according to the embodiment.

FIG. 5A is an enlarged view of a portion of the resin filler of FIG. 4A, and FIG. 5B is an enlarged view of a portion of the resin filler of FIG. 4B.

FIG. 6 is a cross-sectional perspective view of a liquid proof connector according to a modification of the embodiment.

FIG. 7A is a cross-sectional perspective view of the liquid proof connector in the conventional example, and FIG. 7B is an enlarged plan view of the vicinity of a terminal of FIG. 7A.

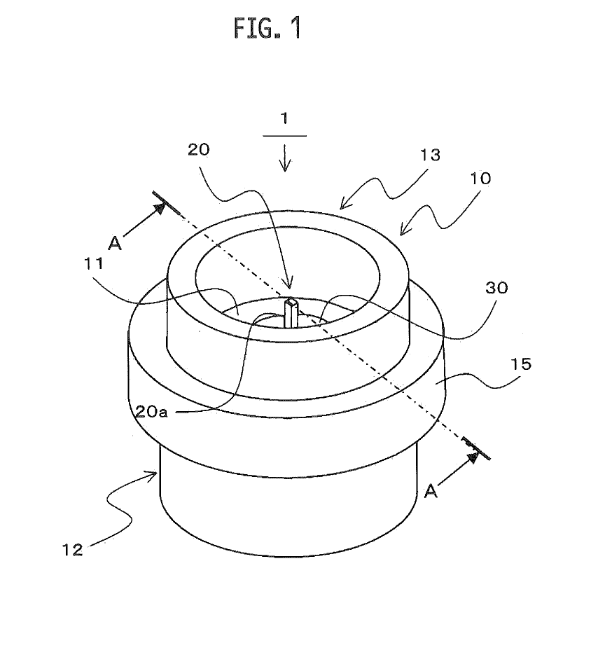

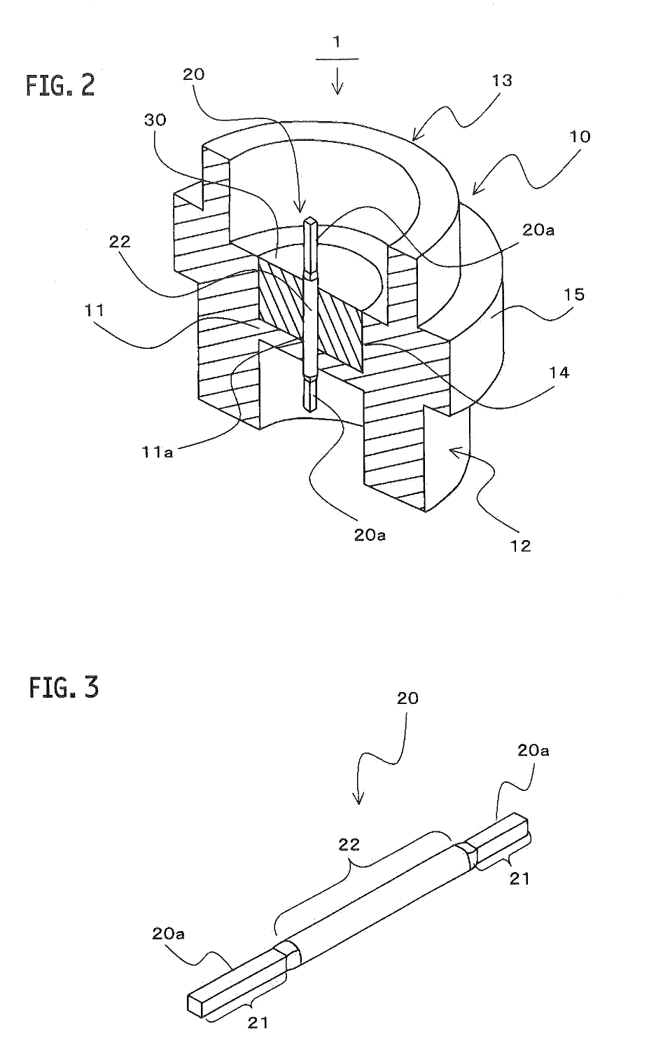

### DESCRIPTION OF EMBODIMENTS

A liquid proof connector according to an embodiment will be described with reference to the drawings. A liquid proof connector 1 according to the embodiment is a connector to be attached to a case accommodating a liquid such as oil, for example, an automotive automatic transmission case. Incidentally, although the liquid proof connector 1 according to the embodiment is exemplified with a simple structure having one terminal 20, the connector includes two or more terminals 20 practically.

The liquid proof connector 1 includes a connector housing 10 including a recessed-section bottom wall 11, two joining recessed-sections 12 and 13 having the recessed-section bottom wall 11 in common and joining openings facing each other in opposite directions, and a terminal holding hole ha formed in the recessed-section bottom wall 11; and a terminal 20 including both ends 20a each having a rectangular shape cross-section and serving as a portion for connection with a partner terminal., the terminal being inserted into the terminal holding hole 11a so that the both ends 20a project into the joining recessed-sections 12, 13 which results in the terminal being held inside the connector housing 10. Further, a resin filler 30 is filled into the connector housing 10.

The connector housing 10 is composed of a cylindrical synthetic resin material whose interior space is partitioned into the two joining recessed-sections 12, 13 by the recessed-section bottom wall 11. The connector housing 10 includes the recessed-section bottom wall 11, the first joining recessed-section 12, the second joining recessed-section 13, the terminal holding hole 11a formed in the recessed-section bottom wall 11, a resin filling part 14 formed in a surface of the recessed-section bottom wall 11 on the side of the second joining recessed-section 13, and a flange part 15 to be fixed to an automatic transmission case as an attached object.

The first joining recessed-section 12 is a portion to be fitted to one of two partner connectors (not illustrated) for connection with the liquid proof connector 1.

The second joining recessed-section 13 is a portion to be fitted to the other one of the two partner connectors (not illustrated) for connection with the liquid proof connector 1.

When a circular cross-section part 22 of the terminal 20 is inserted into the terminal holding hole 11a, it operates to hold the terminal.

The resin filling part 14 is a concave portion to be filled with the resin filler 30 composed of an insulating resin material such as epoxy resin. The resin filling part 14 has an inner circumferential surface formed in a circular shape.

The flange part 15 projects along the outer circumferential surface of the connector housing 10 and is a portion that allows the connector housing 10 to be fixed to the automatic transmission case by fixing members (not illustrated) such as bolts. The flange part 15 is closely-attached to the automatic transmission case since a sealing member, such as an O-ring, is attached between the flange part and the automatic transmission case.

As illustrated in FIG. 3, the terminal 20 includes rectangular cross-section parts 21, which are formed in both ends 21a each serving as a portion for connection with a partner connector's terminal, and a circular cross-section part 22 as a result of forming a terminal's portion embedded in the resin filler 30 so as to have a circular shape cross-section.

The circular cross-section part 22 is formed over a substantially whole area of the terminal 20 except for the both ends 20a. Thus, the circular cross-section part 22 is formed even in peripheral portions of the terminal's portion embedded in the resin filler 30.

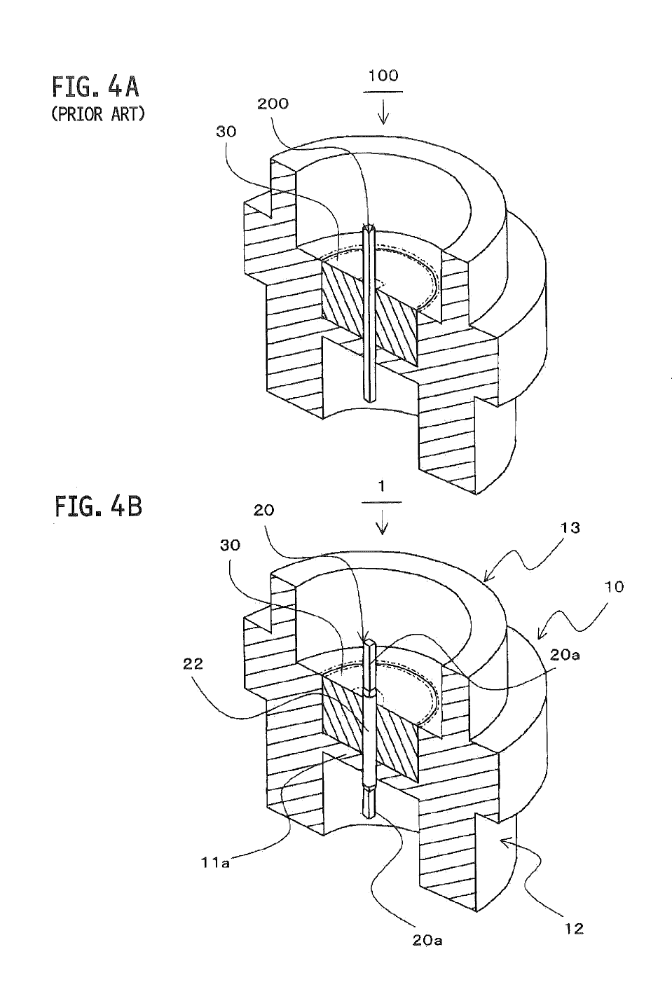

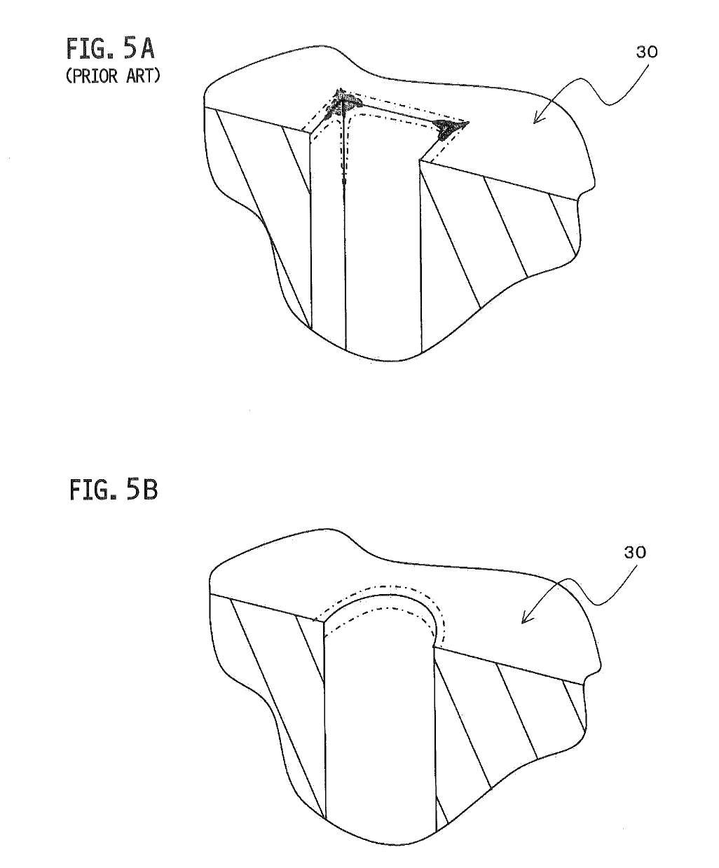

Here, in FIGS. 4A, 4B, 5A, and 5B, there are illustrated analysis results of stress generated in cases of applying thermal impact on: the liquid proof connector 1 according to the embodiment, that is, the liquid proof connector 10 where its portion embedded in the resin filler 30 has a circular shape cross-section; and the conventional liquid proof connector 100 where its portion embedded in the resin filler 30 has a rectangular shape cross-section.

FIG. 4A is a view illustrating the analysis result of stress generated when applying thermal impact on the conventional liquid proof connector 100 where a portion of the terminal 200 embedded in the resin filler 30 has a rectangular shape cross-section, while FIG. 4B is a view illustrating the analysis result of stress generated when applying thermal impact on the liquid proof connector 1 according to the embodiment. FIG. 5A is an enlarged view of a part of the resin filler 30 of FIG. 4A, while FIG. 5B is an enlarged view of a part of the resin filler 30 of FIG. 4B. Note that FIG. 5A and FIG. 5B eliminate the terminal 200 and the terminal 20, respectively. Note that FIGS. 4A, 4B, 5A, and 5B illustrate a distribution of stress by respective sections surrounded by dashed-dotted lines and painting-out sections representing the application of a stress larger than that of the former sections surrounded by the dashed-dotted lines.

As illustrated in FIG. 5A, it is found that the resin filler 30 for embedding the terminal 200 having a rectangular shape cross-section generates a larger stress at corners. For this reason, the resin filler 30 generates, at the periphery of the corners of the terminal 200, a larger stress resulting from the difference of thermal expansion between the terminal 200 and the resin filler 30, so that cracking and peeling occur.

On the other hand, in the resin filler 30 embedding the circular cross-section part 22 of the terminal 20, a smaller stress is applied along the circumference of the circular cross-section part 22 uniformly, as illustrated in FIG. 5B. In the resin filler 30, therefore, cracking and peeling are hardly generated at the periphery of the terminal 20.

In the liquid proof connector 1 according to the embodiment, since the portion of the terminal 20 embedded in the resin filler 30 has the circular shape cross-section, a smaller stress is applied to the resin filler 30 along the circumference of the terminal 20, uniformly. For this reason, cracking and peeling become hardly generated at the periphery of the terminal 20 and consequently, it is possible to improve the liquid proofing performance.

Additionally, the liquid proof connector 1 according to the embodiment is capable of forming the portion of the terminal 20 embedded in the resin filler 30 and a peripheral portion of the terminal's embedded portion so as to have circular shape cross-sections, reliably. Thus, it is possible to prevent an occurrence of cracking and peeling at the periphery of the terminal 20 certainly.

### (Modification)

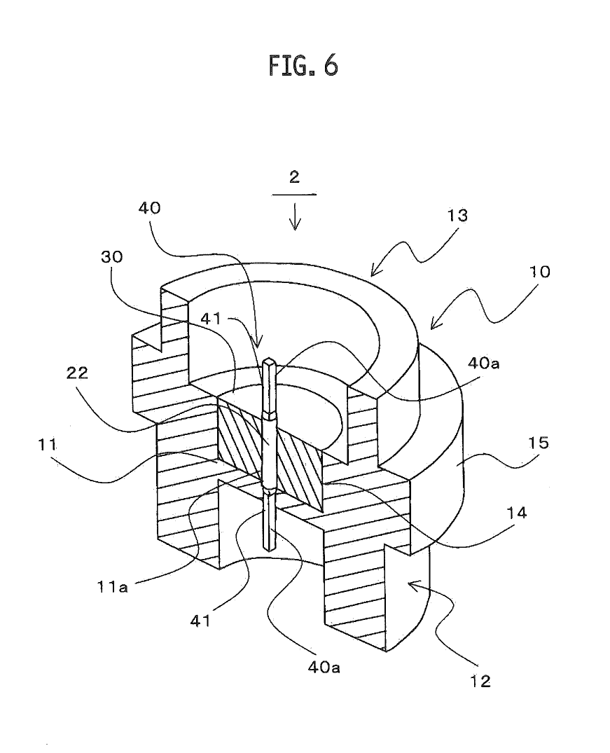

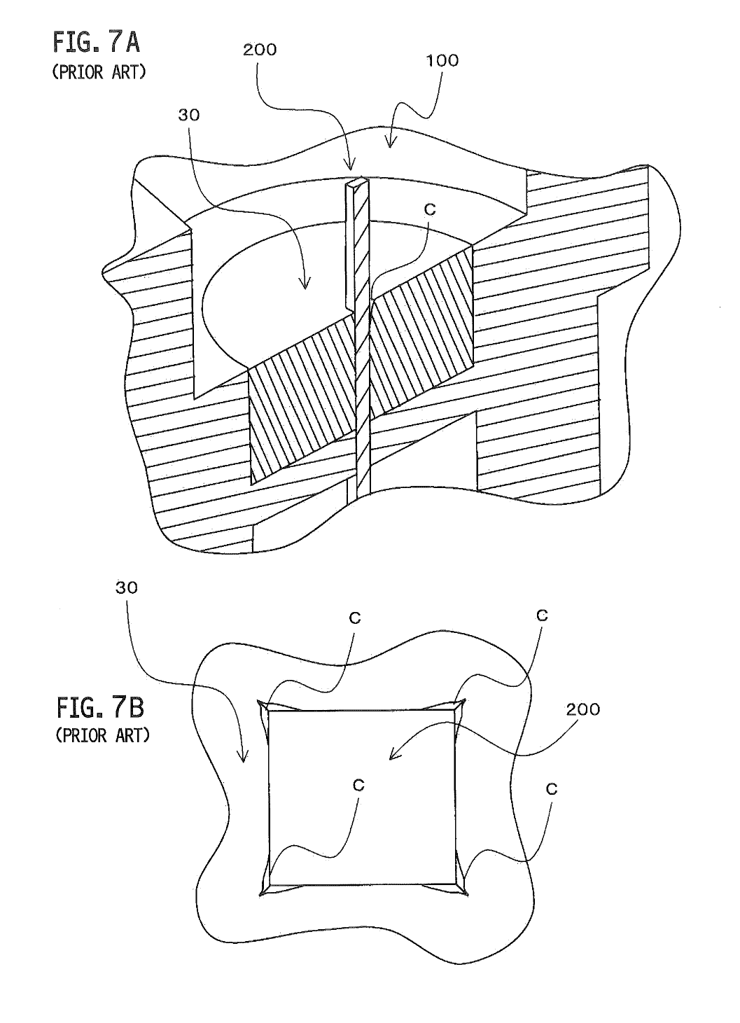

Next, a liquid proof connector 2 according to a modification of the embodiment will be described with reference to FIG. 6. The liquid proof connector 2 according to the modification is different from the liquid proof connector 1 according to the embodiment in that the circular cross-section part 22 is formed only in the portion of a terminal 40 embedded in the resin filler 30. Note that the other constitution of the liquid proof connector 2 according to the modification is similar to that of the connector 1 according to the embodiment and therefore, its constituents identical to those of the connector 1 according to the embodiment are indicated with the same reference numerals respectively.

Since the portion of the terminal 40 embedded in the resin filler 30 has a circular shape cross-section in the liquid proof connector 2 according to the modification, a smaller stress is applied to the resin filler 30 along the circumference of the terminal 40 uniformly, as similar to the liquid proof connector 1 according to the embodiment. Therefore, cracking and peeling become hardly generated at the periphery of the terminal 40 and consequently, it is possible to improve the liquid proofing performance.

Although the embodiments of the present application have been described in detail hereinabove, the present application is not limited to only the above-mentioned embodiments and can be variously modified without departing from the scope of the present application.

What is claimed is:

1. A liquid proof connector, comprising:
a connector housing including a recessed-section bottom wall, two joining recessed sections having the recessed-section bottom wall in common and joining openings facing each other in opposite directions, and a terminal holding hole formed in the recessed-section bottom wall;
a resin filler filled into the connector housing; and
a terminal including both ends each having a rectangular shape cross-section and serving as a portion for connection with a partner terminal, and a circular cross-section part obtained as a result of forming a terminal's portion embedded in the resin filler so as to have a circular shape cross-section, the terminal being inserted into the terminal holding hole so that the both ends project into the joining recessed sections respectively, whereby the terminal is held inside the connector housing.

2. The liquid proof connector of claim 1 wherein the circular cross-section part is formed over a substantially whole area of the terminal except for the both ends.
